(19) United States
(12) Patent Application Publication
(10) Pub. No.: US 2010/0107049 A1
(43) Pub. Date: Apr. 29, 2010

(54) Dynamic Generation of Data Entry Metadata

(75) Inventor: Cayce Benjamin Marston, Boston, MA (US)

Correspondence Address: DUKE W. YEE;YEE & ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/257,084

(22) Filed: Oct. 23, 2008

(51) Int. Cl. G06F 17/30

(52) U.S. Cl. 715/222; 707/E17.005

(57) ABSTRACT

Illustrative embodiments provide a computer implemented method for dynamic generation of data entry metadata. The computer implemented method monitors a form for an event of interest associated with a segment of the form and identifies the event of interest to create an identified event and an active segment. The computer implemented method further triggers a defined computes for the identified event to create generated data entry metadata, updating a metadata data structure with the generated data entry metadata to create updated data entry metadata, and determines whether an update is complete for the active segment. Responsive to a determination that the update is complete, generate a summary of the updated data entry metadata. The summary may be presented to a user.

### BACKGROUND OF THE INVENTION

1. Field of the Invention

The present invention relates generally to an improved data processing system and, more specifically, to a computer implemented method, an apparatus, and a computer program product for dynamic generation of data entry metadata.

2. Description of the Related Art

In the current environment of electronic forms definition and processing, an extensible forms description language (XFDL) may be used in the creation of forms. The extensible forms description language is a dialect of the extensible markup language (XML) and provides a capability to define data fields and layout for forms. The definitions are a class of the extensible markup language specified by the World Wide Web Consortium (W3C) in a specification note of NOTE-XFDL-19980902, Extensible Forms Description Language (XFDL) 4.0, Sep. 2, 1998.

Extensible forms description language is a high-level computer programming language that enables the definition of a form as a single, stand-alone object using extensible markup language elements and attributes. The forms definitions provide control over form layout, permitting replacement of existing business and government forms using a human-readable, open standard. The forms design may then provide enhanced visual and processing capabilities. The forms may then be stored in digital format or display alternatives.

XForms is an extensible markup language application that represents the next generation of forms for the Web. By splitting traditional extensible hypertext markup language, (XHTML), a markup language that has the same depth of expression as hypertext markup language (HTML), but also conforms to extensible markup language syntax, forms into three parts of the XForms model, instance data, and user interface, a separation of the presentation from content is provided, allowing reuse, while providing strong typing and thereby reducing the number of round-trips to the server, as well as offering device independence and a reduced need for scripting. The XFORM specification may be obtained from the World Wide Web Consortium as a current recommendation as the document, XForms 1.0 (Third Edition) W3C Recommendation 29 Oct. 2007 from the site http://www.w3.org/TR/2007/REC-xforms-20071029/.

An extensible forms description language form provides the capability of being sent to any web user as an extensible markup language page. Extensible forms description language also provides a capability to digitally sign an extensible forms description language page, thereby adding security to the forms object. Extensible forms description language describes syntax for inline mathematical and conditional expressions, adding to the processing power of this type of form. Extensible forms description language combines the universal forms definition language (UFDL) that was developed earlier with the power and flexibility of extensible markup language.

Currently, an effective means to generate desired metrics related to the form filling process is not available. Data entry metadata is data collected which provides the desired metrics that describe the data and/or intent capture process of the form filling process. Examples of data entry meta-data include, but are not limited to: total time spent entering data into a form, total time spent entering data within a particular input control or widget within the form, total time spent entering data within a particular section within the form, total time spent entering data within a particular page within the form, total time spent entering form data within a particular stage of a process, the number of times a user has entered and then exited an input control or widget, and the number of times a user has exited a widget and left it either incomplete or in an error condition.

Some data entry metadata generation may be currently provided by custom code to write server-side logs in a form application, typically using a servlet or portlet. In broad terms, a servlet is an object that receives a request, and generates a response based on that request. A servlet may be viewed as simply a function-oriented entity providing dynamic content in a Java™ web serving environment. Portlets are pluggable user interface components that are managed and displayed in a web portal, providing a window into the portal application. For example, a portal may be an email service on a user interface.

Processing server side logs provides a capability to capture either the total time a form document resided on the client side, or the total time taken for a particular form-related stage of a process. The disadvantage of these prior approaches is that more granular information about the form filling experience cannot be obtained. Without detailed results, forms designers, and others, may not have the insight required to understand where time is really being spent during the completion of data collection, review, and approval activities for forms updated by users, for example, when using track changes for suggestions.

### BRIEF SUMMARY OF THE INVENTION

According to one embodiment of the present invention, a computer implemented method for dynamic generation of data entry metadata is provided. The computer implemented method monitors a form for an event of interest associated with a segment of the form and identifies the event of interest to create an identified event and an active segment. The computer implemented method further triggers a defined computes for the identified event to create generated data entry metadata, updates a metadata data structure with the generated data entry metadata to create updated data entry metadata, and determines whether an update is complete for the active segment. Responsive to a determination that the update is complete, generates a summary of the updated data entry metadata.

In another illustrative embodiment, a data processing system for dynamic generation of data entry metadata is provided. The data processing system comprises a monitor capable of monitoring a form for an event of interest associated with a segment of the form; wherein the monitor is capable of identifying the event of interest to create an identified event and an active segment, a defined computes capable of being triggered by the identified event, wherein the defined computes generate data entry metadata for the identified event, a metadata data structure capable of being updated with the data entry metadata for the identified event, and a calculator for calculating totals for the data entry metadata, responsive to a determination that an update is complete for the active segment, to generate a summary of the data entry metadata.

In yet another illustrative embodiment, a computer program product for dynamic generation of data entry metadata is provided. The computer program product comprises a computer-readable recordable type medium having computer-executable instructions tangibly embodied thereon. The computer-executable instructions comprise computer-executable instructions for monitoring a form for an event of interest associated with a segment of the form, computer-executable instructions for identifying the event of interest to create an identified event and an active segment, computer-executable instructions for triggering a defined computes for the identified event to create generated data entry metadata, computer-executable instructions for updating a metadata data structure with the generated data entry metadata to create updated data entry metadata, computer-executable instructions for determining whether an update is complete for the active segment, and computer-executable instructions responsive to a determination that the update is complete, for generating a summary of the updated data entry metadata.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system is shown in which illustrative embodiments may be implemented;

FIG. 3 is a block diagram of components of a dynamic data entry metadata generation system, in accordance with illustrative embodiments;

FIG. 4 is a block diagram of a forms document model in accordance with illustrative embodiments;

FIG. 5 is a text representation of a data structure example for an item of a form, in accordance with illustrative embodiments;

FIG. 6 is a text representation of a data structure example of a page and items within a form, in accordance with illustrative embodiments;

FIG. 7 is a block diagram of a form in accordance with illustrative embodiments;

FIG. 8 is a flowchart of process for the creation of a data structure, used with a form, for dynamic data entry metadata, in accordance with illustrative embodiments; and

FIG. 9 is a flowchart of a dynamic data entry metadata generation process in accordance with illustrative embodiments.

### DETAILED DESCRIPTION OF THE INVENTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wire line, optical fiber cable, RF, etc.

Computer program code for carrying out operations of the present invention may be written in any combination of one or more programming languages, including an object-oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer, or other programmable data processing apparatus, to function in a particular manner, such that the instructions stored in the computer-readable medium produce an article of manufacture, including instruction means which implement the function/act specified in the flowchart and/or block diagram block or blocks.

The computer program instructions may also be loaded onto a computer or other programmable data processing apparatus to cause a series of operational steps to be performed on the computer, or other programmable apparatus, to produce a computer implemented process such that the instructions which execute on the computer, or other programmable apparatus, provide processes for implementing the functions/acts specified in the flowchart and/or block diagram block or blocks.

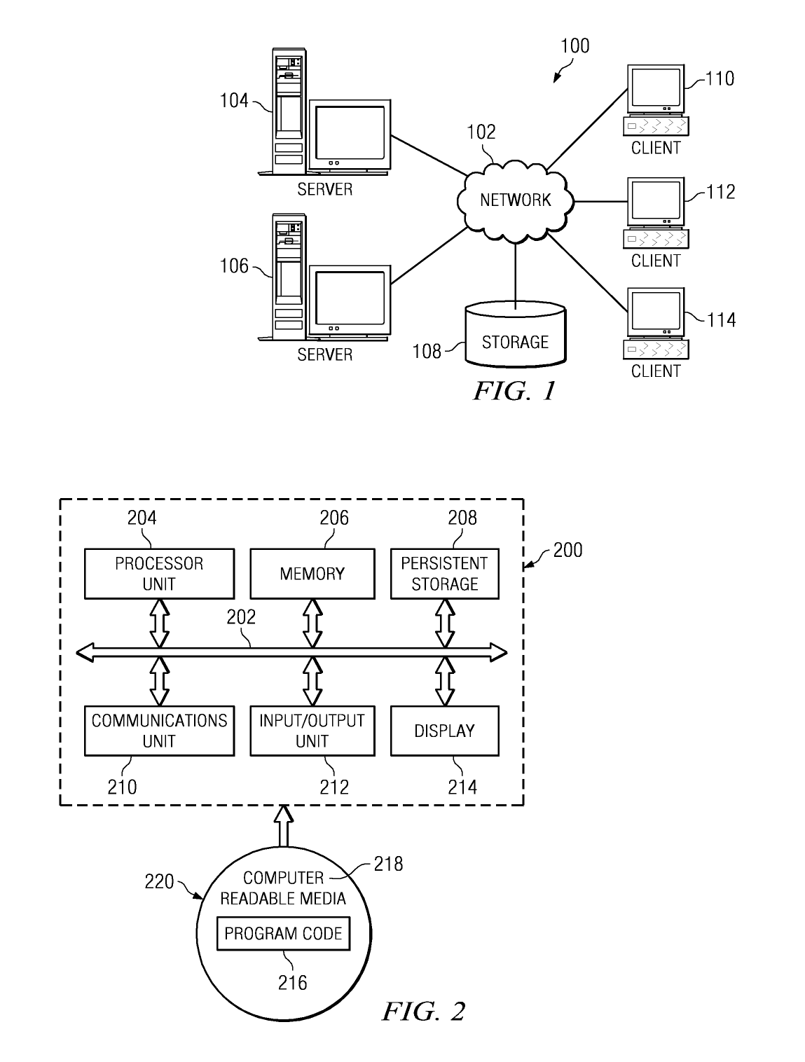

With reference now to the figures, and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

In an illustrative embodiment using data processing system 100 of FIG. 1 as an example, a generic, reusable approach for making electronic forms self-documenting in terms of user-interactions is provided. Data entry meta-data is dynamically generated, and stored within the form in real-time as a user or users participate in the data entry process. For example, a user on client 110 may be in a session completing the filling of a form supplied by server 104 over network 102. As the user completes entry of the required information, data entry information is captured describing the user time spent on various portions of the form and total time spent. The information may then be sent to analysts on client 112 to further aid in the development of responsive forms.

The just described method monitors a form for an indication of a user activity to identify a segment in the form, based on the indication, to create an active segment. The method triggers a defined computes for the active segment and creates generated data entry metadata, and updates a metadata data structure with the generated data entry metadata to create updated data entry metadata. The method further determines whether an update is complete for the active segment and, responsive to a determination that the update is complete, generates a summary of the updated data entry metadata. The summary may be presented to another component or a user.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric, multi-processor system containing multiple processors of the same type.

Memory 206 and persistent storage 208 are examples of storage devices. A storage device is any piece of hardware that is capable of storing information, either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

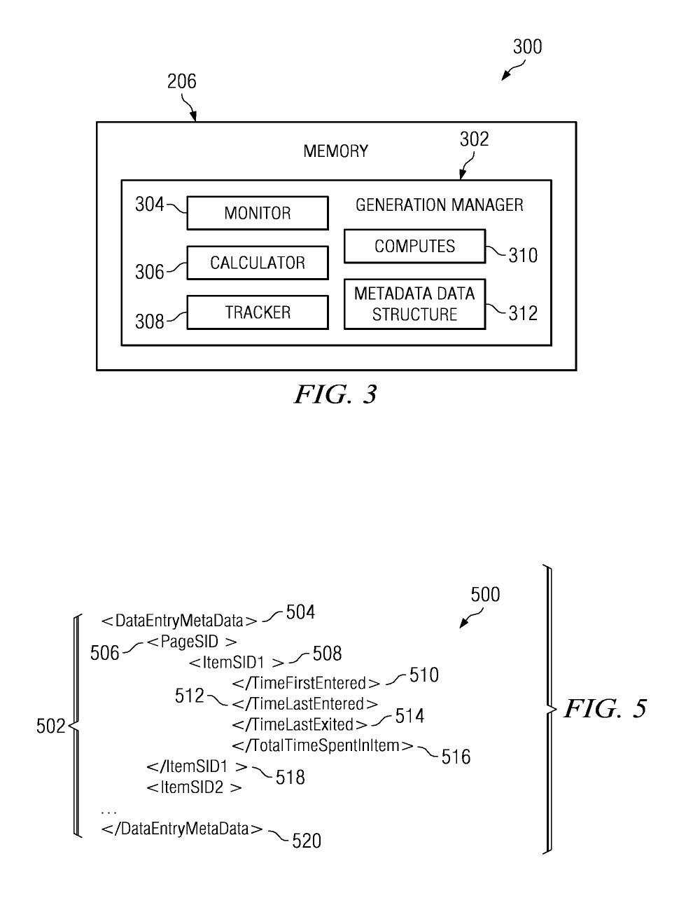

With reference now to FIG. 3, a block diagram of components of a dynamic data entry metadata generation system, in accordance with illustrative embodiments is shown. In one example, dynamic data entry metadata using generation system 300 depicts generation manager 302 within the memory 206 of system 200 of FIG. 2. The components of generation system 300 may be stored in other memory locations of system 200 until ready for use, such as persistent storage 208.

Generation manager 302 contains a number of components including monitor 304, calculator 306, tracker 308, computes 310, and metadata data structure 312. Generation manager 302 for dynamic data entry metadata provides a central point to perform maintenance on the set of components that comprise the manager. Services may be provided separately as pluggable units or as a single module with functional features.

Monitor 304 provides a capability to follow the processing of particular aspects of forms data entry that are of interest to collectors of data entry metrics. Monitor 304 is aware of user-initiated events within the form processing session, such as a change of focus within an application or form.

Calculator 306 provides basic computation operations to derive totals, averages, and similar functions of a statistical nature. The basic operations provide support for reporting on the various aspects of forms data entry operations. For example, a total may be derived from data collected on various segments of forms data entry.

Tracker 308 is used to track progress through a sequence of operations and to determine where within the sequence a user may be, or which particular widget is used. A widget, or a control, is a component of a graphical user interface (GUI). The widget displays information that may be changed by the user, such as a window, a text box, or a button. For an example of the button, the widget provides a focal point for direct manipulation of the data specific to the button.

Computes 310 is the in-form logic used to provide an update rule for an element. The computes are declarative in that the computes define criteria for the desired data. For example, the update rule is triggered on an event and may be used to activate, accumulate, and deactivate counters in the case of data entry metadata generation. The update rule may be set to, on entry to a part of a form, record a timestamp. In addition, computes 310 can perform conditional processing and trigger other events such as sending a summary report after a user completes a forms processing session. Computes 310 may be a set of reusable functions used within and across forms, providing a similar set of capabilities. Computes 310 may also provide specialized logic processing tailored to specific forms or business needs. For example, computes 310 may be used to show or hide sections of forms based on user responses. Computes 310 may also be used to track and report on a particular course a user follows while navigating a form and how long the user stops within sections. The gathered information may then be used as a design aid to improve workflow through the form.

Metadata data structure 312 is a data structure defined to contain the data instances created by the generated outputs of computes 310. Metadata data structure 312 has defined portions unique to each element being processed for which data entry metadata is desired. For example, each data entry field of a form, for which information is to be captured, has a data structure definition entry.

An example, using the components of FIG. 3, of a user completing a form, including an address, may be used to show the relationship between the components just described. When a user opens a form for update, monitor 304 becomes aware of the event. When compute 310 specific to the form is present, a first counter may be established by tracker 308 to indicate time the form was entered. As the user moves from section to section within the form, tracker 308 records the locations. Compute 310 may be used to modify the course of processing depending upon an input value or combination of values. For example, flow may change to expose form sections based on the user response, such as an address being too long and failing an edit check, taking the user to an added input area. As the user spends time on a form section, the time accumulates in the data structure for the specific section and item in the section. For example, when an address line is being completed, a time counter is established on entry and on exit of the address line item. Calculator 306 may be then be used to summarize data values in the address line element of the metadata data structure for the time spent on just the address line or other items defined to be part of the address section of the form.

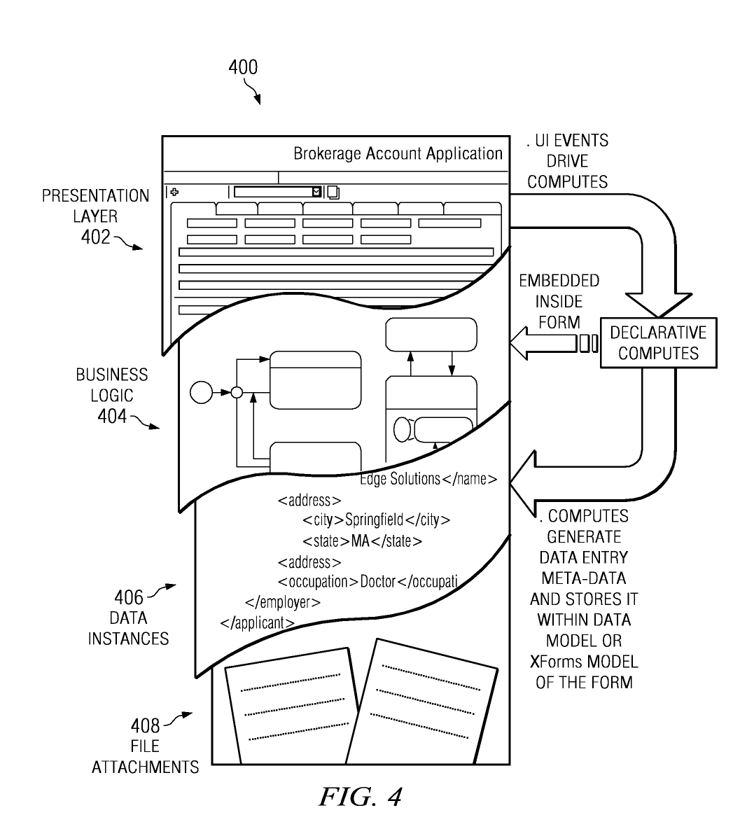

With reference to FIG. 4, a block diagram of a forms document model in accordance with illustrative embodiments is shown. Forms document model 400 shows four separate layers comprising the model. Presentation layer 402 deals with user interface elements of the form to provide the desired look and feel. The user interface provides the placement of the user interface controls enabling the user to interact with the forms.

Business logic 404 provides the logical capability underlying the user interface. Business logic 404 provides the computational element of the form that may also direct the user from one location to another within the form. Actual calculations may also be performed on the data that is entered into the form.

Data instances 406 provides the data structure for the collection of data entered. The implementation does not need to pre-define the extensible markup language structure to store the “counters,” for example, or other data elements related to data entry. The computes themselves are written in a generic way, such that the computes automatically generate the minimal needed data structure. The minimal data structure is generated to correspond with the form user interface implementation. The implementation then need only insert or “drop in” the computes/logic to begin capture of data entry metadata, completely independent of how the form user interface is implemented.

File attachments 408 provides a structured element to define a relationship for attachment of other data, typically documents pertinent to the form. For example, an attachment to an accident report form may be a digital photo file.

A form may then be viewed as a multi-layered object. Each object has a purpose and may be treated separately by specific functions. Events including those events generated by user interface interaction and other events such as a timer event or software based event, for example, closing a document, completing a form or loading a document, drive the processing of the declarative computes. Monitoring such events allows awareness and control of the data flows as needed. The computes, embedded into the forms, provide conditional, rule-based processing of the forms data. The declarative computes provide easily used program control logic to be added to forms. The computes further generate the data entry metadata metrics. The data is the stored with the form data model itself. Other compute functions provide for summarizing and reporting as needed.

The form model provides a form document that can be leveraged to provide computational identification of which user interface control has user focus and which page contains the item of focus. For example, a current item, a previous item, or a current page, may be examples of focus items, depending on the situation.

Changes in the values on the form can be detected within the form itself by the monitoring of the form and listening for events to occur. Actions and computations may then be triggered on the events and value changes detected.

The form document is capable of modifying itself through the capability of writing data into itself in response to events. The data generation dynamically creates the necessary data structure for storing the data collected. An example may be the addition of panels for information, depending upon the need to add comments explaining a claim item in an insurance claim form. The form document has an inherent hierarchy of levels. The upper level is the form, with the next levels of page, item and finally, options. The computes comprise an instance of the options.

With reference to FIG. 5, a text representation of a data structure example for an item of a form, in accordance with illustrative embodiments is shown. Code snippet 500 is an example of the Extensible markup language used to define data entry metadata. The statements follow the general structure of the previously stated hierarchy.

Statement block 502 comprises a number of statements defining a set of items within a page. The dataentrymetadata tag 504 begins the block of statements and is complimented by a closing dataentrymetadata tag 520. After the opening metadata tag is a statement defining the scope of the page, using page SID tag 506.

Within the scope of the page are definitions for each item and within each item, each element of the item. Item SID1 tag 508 introduces the definitions for the first item. Within the item are definitions of timefirstentered 510, timelastentered 512, timelastexited 514, and totaltimespentinitem 516. The first item statements are closed with an ending item SID1 tag 518. Following the first item are further entries for each additional item and respective elements.

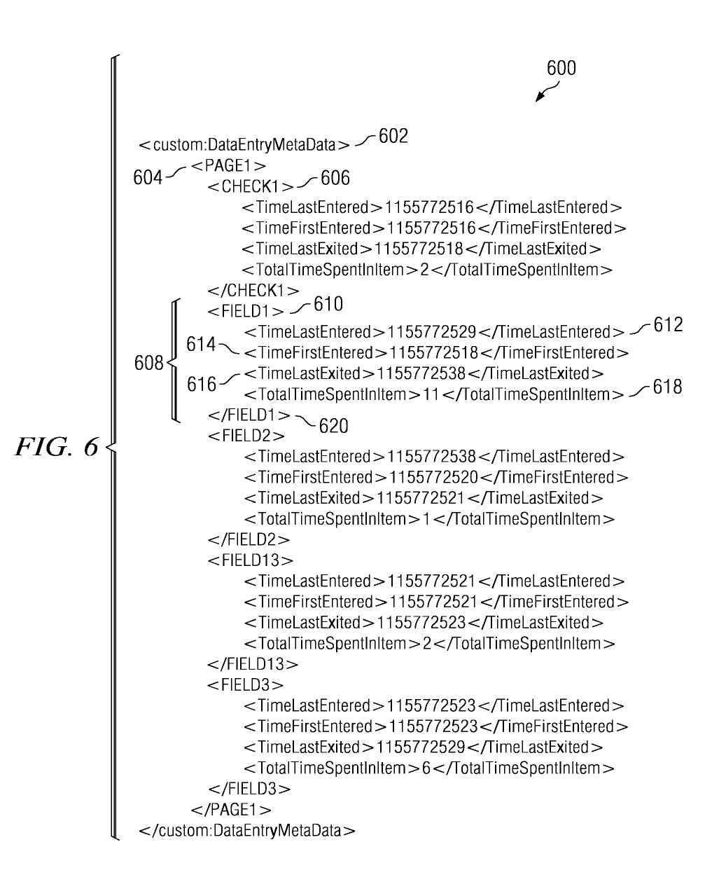

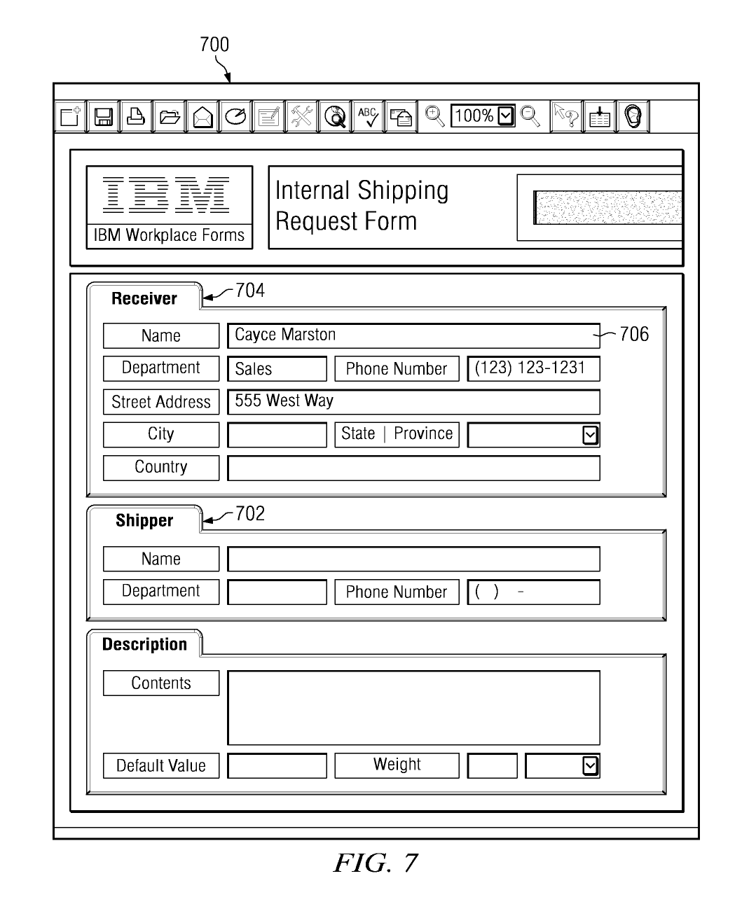

With reference to FIG. 6, a text representation of a data structure example of a page and items within a form, in accordance with illustrative embodiments, is shown. FIG. 6 provides code snippet 600 that illustrates, using Extensible Markup Language, the generated output of a data structure representing use of a portion of the form in FIG. 7. As before, the data structure begins with a dataentrymetadata tag 602. The page1 tag 604 informs that the entries for the page scope now begin.

The entry for the check1 tag 606 provides the beginning of the entries for a check box entry. The next three entries provide time data describing when the field was entered and exited. The fourth entry provides a total time. Entry 608 defines the statements declaring the storage entries for field1 tag 610 entry.

The entry of field1 tag 610 provides the start of definitions for the name field of the form, completed by an ending field1 tag 620. Timelastentered tag 612 provides the timestamp of when the field was last entered. Timefirstentered tag 614 provides a timestamp of when the field was first entered. Timelastexited tag 616 provides a timestamp of when the field was vacated by the user. Totaltimespentinitem tag 618 provides an accumulated amount of time a user spent adding information to the name field.

Other entries are added to complete the definition of the items within the page and a final closing dataentrymetadata tag is provided. The entries in the data structure are used to contain information forming the data entry metrics for the form of interest.

With reference to FIG. 7, a block diagram of a form in accordance with illustrative embodiments is shown. User interface portion 700 shows a portion of sample form 702. Sample form 702 captures information for an internal shipping request, requiring user provided information such as name and address. A segment of the form, receiver 704, contains an item in which the name of the receiver is entered. Name is the user interface label for field1 608 of FIG. 6. When the user providing the information places the cursor in namefield 706 the focus is on field1 608. field1 608 becomes the active segment and timestamps are obtained. The timing information captured for the entry is as described in the elements of field1 608 of FIG. 6. In a similar manner, other fields may have declarations provided to capture data entry metadata and stored in the defined data structure.

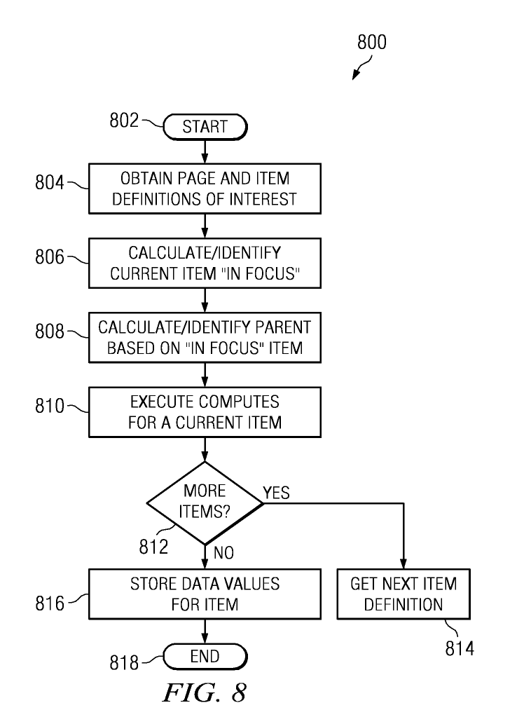

With reference to FIG. 8, a flowchart of a process for the creation of a data structure, used with a form, for dynamic data entry metadata, in accordance with illustrative embodiments is shown. Process 800 is an example of a process such as that of generation manager 302 of FIG. 3.

Process 800 begins (step 802) and obtains page and associated item definitions of interest (step 804). The definitions of interest are obtained from an extensible markup language forms definition, or similar forms definition for electronic forms. Calculate/identify current items in focus is performed (step 806). Calculate/identify the current parent of the in focus item is performed (step 808). The computations are used to identify, for example, which user interface control has the user focus and which page contains the item of focus. The page is typically identified as the parent node of the current item. The active segment of the user interface is the portion of the interface that contains the in focus item. Calculations may be sequential such as when determining a page because the page is determined based on the current item that has focus.

When an event is detected, such as a change in focus or a value being updated, all dependent calculations are also updated. The structure of the current form interface determines the depth of dependent or child elements that are processed. The form, page, item hierarchy is one instance of a structure. Other examples may provide more complex relationships of differing scope.

Execute computes for a current item in focus is performed (step 810) based on an event such as, being aware of changes in the form, and particularly, in the active segment. This action provides a capability to detect changes in values and trigger actions and computations based on the changes.

A determination is made whether more items are present (step 812). When there are more items to be processed, a “yes” is obtained. When there are no more items to process, a “no” result is obtained.

As with any programming language there are multiple ways to implement specific functions. In this example, comparisons are used to determine a “yes” or “no” result. The actual value of yes or no is not the point of the logic. The logic implementation provides a true or false result of testing a condition. The use of terms yes and no provide clarity in the text and is not meant to be limiting to the implementation of the logic.

When a “yes” result is obtained in step 812, get next item definition is performed (step 814). The next item is obtained and process 800 loops back to step 810 to execute computes for the items. When a “no” result is obtained in step 812, store data values for each item is performed (step 816) with process 800 terminating thereafter (step 818).

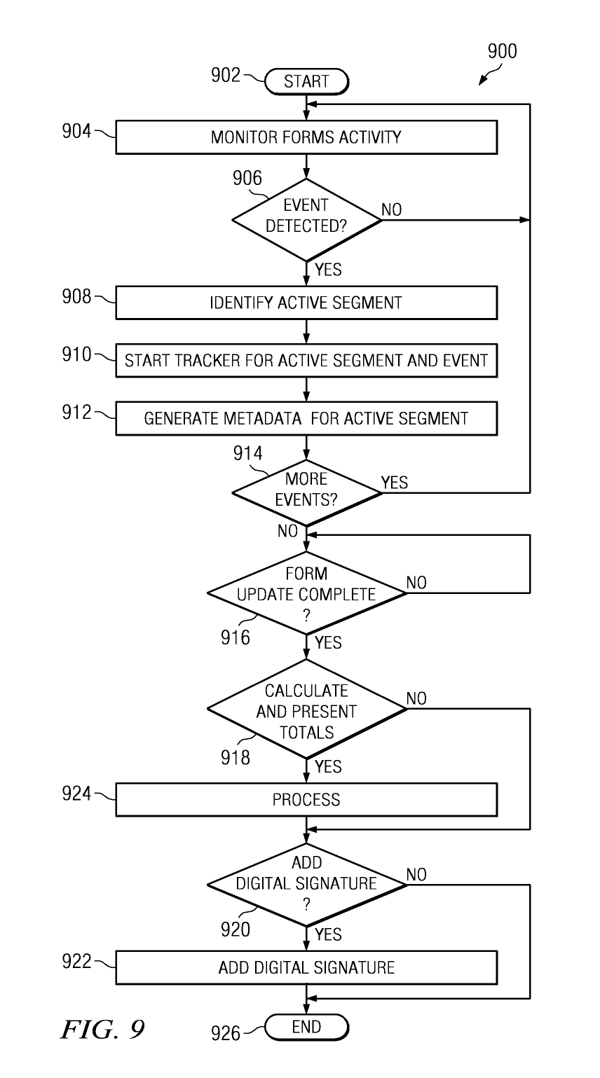

With reference to FIG. 9, a flowchart of a dynamic data entry metadata generation process in accordance with illustrative embodiments is shown. Process 900 is an example operation of the dynamic data entry metadata generation manager 302 of FIG. 3.

Process 900 starts (step 902) and begins monitoring the forms processing (step 904). Activation of a form is used as a trigger to initiate process 900. A determination is made as to whether a particular segment or portion of a form is active and event is triggered (step 906). Active in this sense means the user is working in an area of the form and is one of many events that may be triggered. Data is not necessarily being entered to define an active segment. A section that is “in focus,” such as when being viewed, is also tracked and monitored as an active segment. For example, a mouse over of a segment will cause that segment be “in focus” and deemed active. Other events such as a timer event or software event of a page load will cause the page to be active when that page is in the current active window. When a segment is active, a “yes” result is obtained. When there is not any activity, including viewing as an activity, a “no” result is obtained. When a “no” result is obtained, process 900 loops back to step 904.

When a “yes” result is obtained in step 906, process 900 is responsive to a determination that a segment is active, and an operation is performed to identify the active segment (step 908). An identifier of an active segment may be useful in later analysis of the data captured. A tracker for the active segment and the trigger event is started to provide proper containers for the accumulation of the generated metadata (step 910). A tracker may be a set of specialized memory locations allocated for accumulating data in the form of a set of counts, a set of counters, or timer signals, for example, as well as other data defined as useful for understanding form usage. A set may be comprised of one or more elements. For example, a set of counters may be one or more counters. Similarly, a set of trackers may be one or more trackers as needed.

Generate metadata for the active segment data is performed (step 912). For example, in a simple case, there may be a counter that is started as a user enters a form segment, and then stopped when a user exits. The time accumulated would then be available for reporting as time for an activity within the specific segment and recorded as generated metadata.

A determination is made as to whether there is more than one event (step 914). If there is more than one event, a “yes” result occurs. When there is only a single event, a “no” result is obtained. When a “yes” result is obtained in step 914, process 900 loops back to step 904 to initiate the process for each of the additional events. When a “no” result is obtained, a determination is made as to whether the form update is complete (step 916). A form update may comprise a data entry operation or may comprise completion of viewing of a segment or portion. The form segment or portion is only viewed from the perspective of the form presentation and not the form processing. The form is processed in a hierarchy, for example, ranging from a high of form, to a page and then to an item. The form structure determines the depth and breadth of the compute requirements. When a form update is complete, a “yes” result is obtained. When a form update has not been completed, a “no” result is obtained. When a “no” result is obtained in step 916, process 900 loops back to perform step 916.

When a “yes” result is obtained in step 916, a determination is made to calculate totals and present totals is performed (step 918). When a determination is made to calculate totals, a “yes” is obtained. When totals are not desired a “no” is obtained. When a “yes” is obtained in step 918, the generated metadata of the counters or containers used to accumulate data for the segment may then be totaled or otherwise summarized, to provide the information on activity of the forms user. A summary of forms activity may then be made available (step 924). Summarization may typically occur outside of the forms process, such as in a extensible markup language enabled database management processing environment. Key performance indicators, for example in the form of software such as “dashboards” can then provide real-time insight and alerts based on the generated to managers and executives. Summarization and presentation may typically involve data aggregation including information from other sources and forms processing.

A determination is made as to whether a digital signature is to be added to the form information (step 920). When a digital signature is to be added to the form information a “yes” is obtained. When no digital signature is desired a “no” result is obtained. When a “yes” is obtained in step 920, a digital signature is added to the form information to secure the data including the recent data entry metadata. When a “no” is obtained in step 920, process 900 terminates (step 926).

Illustrative embodiments provide a capability for a generic, reusable approach for making electronic forms self-documenting in terms of user interactions. Data entry metadata is dynamically generated, and stored within the form in real-time as a user participates in the data entry process. The data is then summarized on completion of forms processing, or selectively, as logical segments are processed to completion. Various types of conditional processing, implemented as computes embedded in the form, may be used to gather data on selected elements of interest within the scope of the form being processed. Data resulting from the processing of the form may be sent to a collection point for further processing, display, or storage. A summary may be presented to the user or other designated component or person.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose, hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, as well as to enable others of ordinary skill in the art to understand the invention for various embodiments with various modifications, as are suited to the particular use contemplated.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by, or in connection with, a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, or remote printers, or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for dynamic generation of data entry metadata, the computer implemented method comprising:
monitoring a form for an event of interest associated with a segment of the form;
identifying the event of interest to create an identified event and an active segment;
triggering a defined computes for the identified event to create generated data entry metadata;
updating a metadata data structure with the generated data entry metadata to create updated data entry metadata;
determining whether an update is complete for the active segment; and
responsive to a determination that the update is complete, generating a summary of the updated data entry metadata.

2. The computer implemented method of claim 1, wherein monitoring the form for an event of interest comprises:
determining whether the event of interest associated with one of activity and inactivity occurred; and
responsive to a determination that the event of interest associated with inactivity occurred, logging the identified event.

3. The computer implemented method of claim 1, wherein updating the metadata data structure with the generated data entry metadata comprises:
starting a set of trackers for the identified event and the active segment.

4. The computer implemented method of claim 1, wherein monitoring a form for an event of interest comprises:
determining whether there is more than one segment; and
responsive to a determination that there is more than one segment, identifying a plurality of segments and monitoring the plurality of segments.

5. The computer implemented method of claim 1, wherein generating a summary of the updated data entry metadata comprises;
calculating totals for the data entry metadata to form the summary.

6. The computer implemented method of claim 1, wherein responsive to a determination that updating is not complete, continuing to monitor the form.

7. The computer implemented method of claim 1, further comprises:
presenting the summary to a user.

8. A data processing system for dynamic generation of data entry metadata, the data processing system comprising:
a monitor capable of monitoring a form for an event of interest associated with a segment of the form; wherein the monitor is capable of identifying the event of interest to create an identified event and an active segment;
defined computes capable of being triggered by the identified event, wherein the defined computes generate data entry metadata for the identified event;
a metadata data structure capable of being updated with the data entry metadata for the identified event; and
a calculator for calculating totals for the data entry metadata, responsive to a determination that an update is complete for the active segment, to generate a summary of the data entry metadata.

9. The data processing system of claim 8, wherein a monitor capable of monitoring further comprises a capability to:
determine whether the event of interest associated with one of activity and inactivity occurred; and
responsive to a determination that the event of interest associated with inactivity occurred, logging the event.

10. The data processing system of claim 8, wherein the defined computes capable of being triggered by the identified event comprise a capability to:
start a set of trackers for the identified event and the active segment.

11. The data processing system of claim 8, wherein a monitor capable of monitoring a form for an event of interest further comprises:
a capability to determine whether there is more than one segment; and responsive to a determination that there is more than one segment, identifying a plurality of segments and monitoring the plurality of segments.

12. The data processing system of claim 8, wherein a calculator for calculating totals for the data entry metadata calculates totals for the data entry metadata for each active segment of the form.

13. The data processing system of claim 8, wherein the monitor, responsive to a determination that an update is complete for the active segment, continues to monitor the form.

14. The data processing system of claim 8, wherein a calculator for calculating totals for the data entry metadata calculate totals for the data entry metadata for the active segment, further comprises:
a capability for presenting the summary to a user.

15. A computer program product for dynamic generation of data entry metadata, the computer program product comprising a computer-readable recordable type medium having computer-executable instructions tangibly embodied thereon; the computer-executable instructions comprising:
computer-executable instructions for monitoring a form for an event of interest associated with a segment of the form;
computer-executable instructions for identifying the event of interest to create an identified event and an active segment;
computer-executable instructions for triggering a defined computes for the identified event to create generated data entry metadata;
computer-executable instructions for updating a metadata data structure with the generated data entry metadata to create updated data entry metadata;
computer-executable instructions for determining whether an update is complete for the active segment; and
computer-executable instructions responsive to a determination that the update is complete, for generating a summary of the updated data entry metadata.

16. The computer program product of claim 15, wherein computer-executable instructions for monitoring a form for an event of interest associated with a segment of the form comprises:
computer-executable instructions for determining whether the event of interest associated with one of activity and inactivity occurred; and
computer-executable instructions responsive to a determination that the event of interest associated with inactivity occurred, for logging the identified event.

17. The computer program product of claim 15, wherein computer-executable instructions for updating the data entry metadata data structure with the generated data entry metadata comprises:
computer-executable instructions for starting a set of trackers for the identified event and active segment.

18. The computer program product of claim 15, wherein computer-executable instructions for updating the data entry metadata data structure with the generated data entry metadata comprises:
computer-executable instructions for determining whether there is more than one segment; and
computer-executable instructions responsive to a determination that there is more than one segment, identifying a plurality of segments and monitoring the plurality of segments.

19. The computer program product of claim 15, wherein computer-executable instructions responsive to a determination that the update is complete further comprises:
computer-executable instructions for calculating totals for the data entry metadata to form the summary; and
computer-executable instructions for presenting the summary to the user.

20. The computer program product of claim 15, wherein computer-executable instructions responsive to a determination that the update is not complete for continuing to monitor the form.
